(19) United States
(12) Patent Application Publication
(10) Pub. No.: US 2016/0223675 A1
(43) Pub. Date: Aug. 4, 2016

(54) MOBILE TERMINAL, POSITION IDENTIFICATION METHOD, AND POSITION IDENTIFICATION DEVICE

(71) Applicant: FUJITSU LIMITED, Kawasaki-shi (JP)

(72) Inventors: TAKASHI MIURA, Kawasaki (JP); YUI NOMA, Kawasaki (JP); MAKIKO KONOSHIMA, Kawasaki (JP)

(73) Assignee: FUJITSU LIMITED, Kawasaki-shi (JP)

(21) Appl. No.: 14/988,898

(22) Filed: Jan. 6, 2016

(30) Foreign Application Priority Data
Jan. 30, 2015 (JP) 2015-017717

(51) Int. Cl. G01S 19/13; H04B 1/3827

(52) U.S. Cl. CPC G01S 19/13; H04B 1/3827

(57) ABSTRACT

A mobile terminal includes an obtaining unit that obtains position information and time information of a plurality of satellites; a first output unit that outputs a variable for use for projection of a first coordinate system, to a projection surface defined in a second coordinate system, the second coordinate system being higher in dimension than the first coordinate system representing the position information and time information; a second output unit that outputs coordinates of the second coordinate system where the projection surface is present, the coordinates being computed using the position information and time information and the variable; and a transformation unit that transforms the coordinates output by the second output unit to coordinates of the first coordinate system.

### CROSS-REFERENCE TO RELATED APPLICATION

This application is based upon and claims the benefit of priority of the prior Japanese Patent Application No. 2015-017717, filed on Jan. 30, 2015, the entire contents of which are incorporated herein by reference.

### FIELD

The embodiments discussed herein are related to a mobile terminal, a position identification method, a position identification program, and a position identification device.

### BACKGROUND

The global positioning system (GPS), which is a satellite positioning system, is conventionally known as a method of measuring the distance to a position reference station using radio waves. This system uses a combination of information on times (t^{(s)}) and positions (x^{(s)}, y^{(s)}, z^{(s)}) broadcast from satellites and time information (t) of a receiver and thus identifies a position (x, y, z) at which the receiver is present.

Typically, the accuracy of a clock on a receiver side is not very high, causing a time error (δ) of a receiver. In order to identify the position of the receiver under such a condition, since four unknown variables (x, y, z, δ) are present, the unknown variables are identified using four equations. Computation is repeated using the equations for identifying unknown variables until the residual resulting from a linear approximation of a receiver becomes less than a given convergence value, so that the position of the receiver is determined.

Examples of the related art technique include Japanese Laid-open Patent Publication No. 2012-2820, Japanese Laid-open Patent Publication No. 2002-250624, Japanese National Publication of International Patent Application No. 2006-520168, Japanese National Publication of International Patent Application No. 8-512130, and Japanese National Publication of International Patent Application No. 2006-518886.

### SUMMARY

According to an aspect of the invention, a mobile terminal includes an obtaining unit that obtains position information and time information of a plurality of satellites; a first output unit that outputs a variable for use for projection of a first coordinate system, to a projection surface defined in a second coordinate system, the second coordinate system being higher in dimension than the first coordinate system representing the position information and time information; a second output unit that outputs coordinates of the second coordinate system where the projection surface is present, the coordinates being computed using the position information and time information and the variable; and a transformation unit that transforms the coordinates output by the second output unit to coordinates of the first coordinate system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an overall configuration of a system according to a first embodiment;

FIG. 2 is a diagram for explaining a typical position measurement method using a GPS;

FIG. 3A is a diagram for explaining the correspondence relationship between a hypersurface and four-dimensional spacetime;

FIG. 3B is a diagram for explaining the relationship between a four-dimensional hyperplane and the hypersurface;

FIG. 4 is a functional block diagram illustrating a functional configuration of a receiver according to the first embodiment;

FIG. 5 is a diagram illustrating an area for which it is determined whether or not inverse stereographic projection is possible for satellites;

FIG. 6 is a diagram taken along the X₀-X₅ plane of FIG. 3A or FIG. 3B;

FIG. 7 is a flowchart illustrating a process flow; and

FIG. 8 is a diagram illustrating an example of a hardware configuration of a mobile terminal.

### DESCRIPTION OF EMBODIMENTS

However, in the above technique described in BACKGROUND, since, in order to measure the position of a receiver, computation has to be repeated many times for one identification of the position using equations for identifying unknown variables. This makes it difficult to reduce the amount of computation. It is therefore difficult to reduce the power consumption of the receiver attributed to the amount of computation.

Accordingly, it is desired to provide a mobile terminal, a position identification method, a position identification program, and a position identification device that may reduce power consumption.

Hereinafter, an embodiment of a mobile terminal, a position identification method, a position identification program, and a position identification device disclosed in the present application will be described in detail with reference to the accompanying drawings. It is to be noted that the present disclosure is not limited by the embodiment.

### First Embodiment

[Overall Configuration]

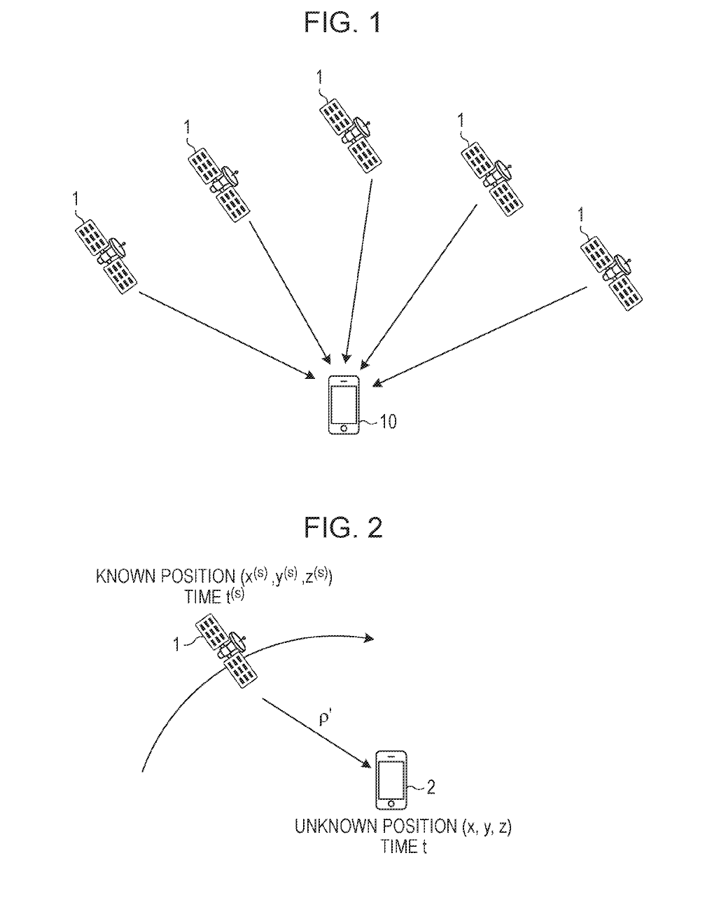

FIG. 1 is a diagram illustrating an example of an overall configuration of a system according to a first embodiment. As illustrated in FIG. 1, in this system, a plurality of satellites 1 and a receiver 10 are communicatively coupled. Each satellite 1, which is an example of a position reference station, transmits information on the position of itself and a time to the receiver 10. The receiver 10 is a device that identifies the position of itself using position information and times obtained from the satellites 1. The receiver 10 is an example of a mobile terminal such as, for example, a smart phone or a mobile phone.

In such a situation, the receiver 10 performs inverse stereographic projection from four-dimensional Minkowski spacetime (hereinafter sometimes referred to simply as four-dimensional spacetime) onto a hypersurface to rewrite a non-linear equation in the four-dimensional spacetime into a linear equation and solves the linear equation.

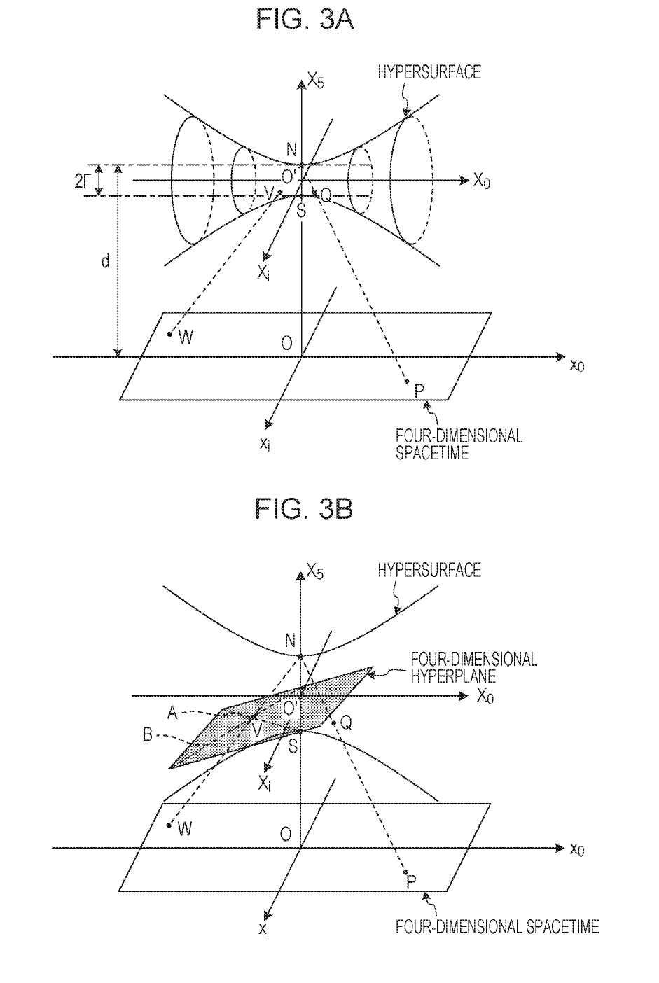

Here, with reference to FIG. 2, FIG. 3A, and FIG. 3B, an equation in the case of using a typical GPS and an equation in the case of using a technique according to the first embodiment will be described. FIG. 2 is a diagram for explaining a typical position measurement method using a GPS. In a system illustrated in FIG. 2, using a combination of the position (x^{(s)}, y^{(s)}, z^{(s)}) and a time t^{(s)} of a satellite, which are known, and a time t of a receiver, the position (x, y, z) of a receiver 2, which is unknown, is identified. Note that “s” in the present embodiment is a label corresponding to the number of satellites; for example, when four satellites are provided, s has a value of one, two, three, or four.

Specifically, the typical receiver 2 obtains the positions and times from four satellites and, from them, computes a pseudorange ρ′ between each satellite 1 and the receiver 2 (see equation (1)). Then, the receiver 2 performs a linear approximation of the expression inside the radical symbol in equation (1), as expressed by equation (2). Thereafter, the receiver 2 performs a linear approximation of the pseudorange ρ′ and performs expansion and then, using a successive approximation, computation is repeated until the time error (δ) and the residual (δx, δy, δz) become less than or equal to given convergence values. Therefore, there is a large number of computations during each measurement, leading to large power consumption. Note that “c” of equation (1) is the speed of light.

ρ′=c(t−t^{(s)})={square root over ((x−x^{(s)})²+(y−y^{(s)})²+(z−z^{(s)})²)}−cδ (1)

x≈x₀+δx, y≈y₀+δy, z≈z₀+δz (2)

While on the other hand, the receiver 10 according to the first embodiment rewrites a non-linear equation in the four-dimensional spacetime to a linear equation. FIG. 3A is a diagram for explaining the correspondence relationship between a hyperspace and the four-dimensional spacetime.

As illustrated in FIG. 3A, stereographic projection is defined as a map f from a point V on a hypersurface to a point W in the four-dimensional spacetime when a straight line passing from a point N, which is the starting point of inverse stereographic projection, through the point V is drawn, and an inverse map f⁻¹ from the point W to the point V is defined by equation (3). In addition, “r²” in equation (3) is defined by equation (4).

$$\begin{matrix}{f}^{- 1} ( {x}_{0} , {x}_{i} ) = ( \frac{2 d Γ {x}_{0}}{{r}^{2} - {x}_{0}^{2} + {d}^{2}} , \frac{2 d Γ {x}_{i}}{{r}^{2} - {x}_{0}^{2} + {d}^{2}} , Γ \frac{2 {d}^{2} Γ }{{r}^{2} - {x}_{0}^{2} + {d}^{2}} ) \\ = ( {X}_{0} , {X}_{i} , {X}_{5} )\end{matrix} \qquad ( 3 )$$

r²=ρᵢ³⁼¹xᵢ² (4)

Note that a point O in FIG. 3A is the origin of the four-dimensional spacetime and a point O′ is the origin of five-dimensional spacetime in which the hypersurface is present. A point P is the positon of the receiver 10 in the four-dimensional spacetime, that is, the position of an object to be identified. The point W is the position of the satellite 1 in the four-dimensional spacetime. The point N, which is the starting point of the inverse stereographic projection, is (X₀, X₁, X₂, X₃, X₅)=(0, 0, 0, 0, Γ) when expressed in coordinates, and a point S is (X₀, X₁, X₂, X₃, X₅)=(0, 0, 0, 0, −Γ) when expressed in coordinates. “Γ” is the radius of an opening around the origin of the hypersurface. A variable “d”, which is the distance from the origin O of the four-dimensional spacetime to the point N, is in some cases hereinafter referred to as a variable d.

Here, the relationship between a four-dimensional hyperplane and the hypersurface will be described. FIG. 3B is a diagram for explaining the relationship between a four-dimensional hyperplane and the hypersurface. As illustrated in FIG. 3B, the four-dimensional hyperplane comes in contact with the hypersurface at the point V, which corresponds to the point W in FIG. 3A, and intersects the hypersurface along a dotted line A and a dotted line B. The dotted line A and the dotted line B, along which the four-dimensional hyperplane and the hypersurface intersect, represent the paths of light in the five-dimensional spacetime. The four-dimensional hyperplane including the dotted line A and the dotted line B is a surface on which the paths of light at the point W of the four-dimensional spacetime is representable by a linear equation.

As illustrated in FIG. 3A and FIG. 3B, the receiver 10 performs inverse stereographic projection onto the hypersurface so as to rewrite equation (1), which is a non-linear equation, to equation (5), which is a linear equation. At this point, the receiver 10 sets the variable d with which the position of each satellite in the four-dimensional spacetime is inside the hyperboloid in the four-dimensional spacetime.

−x₀^{(s)}X₀+Σᵢ³⁼¹xᵢ^{(s)}X ᵢ+α^{(s)}X₅=β^{(s)} (5)

That is, the receiver 10 sets the variable d, which is the distance from the origin O in the four-dimensional spacetime to the point N illustrated in FIG. 3A, to a suitable value. The receiver 10 then transforms a value obtained by equation (5) to coordinates of the four-dimensional spacetime so as to identify the position of the receiver 10. Therefore, the receiver 10 may identify the position, without performing the repetition of an approximation computation performed in an existing computation method using a GPS. The power consumption may thus be reduced.

In addition, “x₀^{(s)}” in equation (5) is obtained by multiplication of the speed of light c by the time t of the satellite 1. In equation (5), “xᵢ (i=1, 2, 3)” is position information in the four-dimensional space such that (x₁^{(s)}, x₂^{(s)}, x₃^{(s)})=(x^{(s)}, y^{(s)}, z^{(s)}). “Xᵢ” and “X₅” are variables in the five-dimensional space. Variable “α” and variable “β” are variables, which will be described in more detail below.

[Functional Configuration]

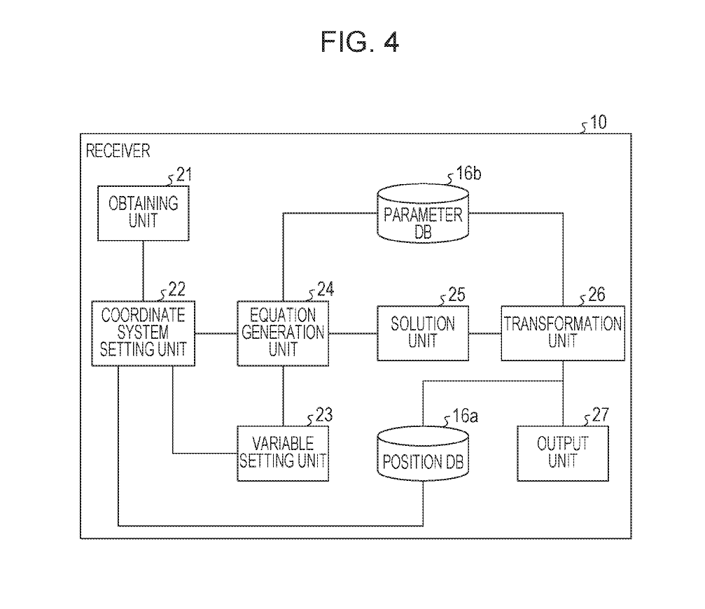

FIG. 4 is a functional block diagram illustrating a functional configuration of a receiver according to the first embodiment. As illustrated in FIG. 4, the receiver 10 includes a position DB 16a, a parameter DB 16b, an obtaining unit 21, a coordinate system setting unit 22, a variable setting unit 23, an equation generation unit 24, a solution unit 25, a transformation unit 26, and an output unit 27.

Note that the position DB 16a and the parameter DB 16b are databases stored in a storage device such as a memory or a hard disk. The obtaining unit 21, the coordinate system setting unit 22, the variable setting unit 23, the equation generation unit 24, the solution unit 25, the transformation unit 26, and the output unit 27 are exemplary electronic circuits mounted on a processor and exemplary processes executed by the processor.

The position DB 16a stores the position information of the identified receiver 10. Specifically, the position DB 16a stores position information represented by coordinates (x, y, z, t) of the four-dimensional spacetime where the receiver 10 and the satellites are present. Note that (x, y, z) is information identifying a position and (t) is a time.

The parameter DB 16b stores parameters related to inverse stereographic projection. Specifically, the parameter DB 16b stores a set value of “Γ” illustrated in FIG. 3A and so on. This Γ is used to reduce rounding errors produced during computations and may be set arbitrarily by an administrator or the like. For example, an administrator may set Γ so that d/Γ is approximately one, depending on an expected magnitude of the variable d. Note that, in the present embodiment, description is given by way of example assuming that Γ=1.

The obtaining unit 21 is a processing unit that obtains the position information and time information of satellites and the time information of the receiver 10. Specifically, the obtaining unit 21 obtains the position information and time information from five satellites at the first time of measurement of position information of the receiver 10 and obtains the position information and time information from four satellites after the first time. Then, the obtaining unit 21 outputs each information obtained to the coordinate system setting unit 22.

Note that each information obtained here is coordinates of the four dimensional spacetime. In addition, the position information of a satellite obtained here is (x^{(s)}, y^{(s)}, z^{(s)}) and the time information of the satellite is (t^{(s)}).

The coordinate system setting unit 22 is a processing unit that sets the origin of each of coordinate systems when inverse stereographic projection is performed from four-dimensional spacetime onto a hypersurface. Specifically, the coordinate system setting unit 22 sets the origin of each of the coordinate systems based on information notified from the obtaining unit 21 and sets the position relationship between the origin of the coordinate system in four-dimensional spacetime and the origin of the coordinate system in five-dimensional spacetime. Then, the coordinate setting unit 22 outputs information on the set origins and the time information and position information of the satellite 1, which are input from the obtaining unit 21, to the variable setting unit 23 and the equation generation unit 24.

By way of example, the coordinate system setting unit 22 sets the angle between two axes x₀ and X₅ and the angle between xᵢ and X₅ to be at right angles, as the position relationship between the origin O of the four-dimensional spacetime and the origin O′ of the five-dimensional spacetime in FIG. 3A. The coordinate setting unit 22 also sets the current time of the receiver 10 regarding the origin of time. Regarding the origin of the space coordinates, the coordinate setting unit 22 employs a known geodetic system and sets the origin, at the first time of measurement, and sets the position of the receiver 10, at the second or more time. Here, the geodetic system is a system for representing positions on the earth in coordinates using longitudes and latitudes and sea levels, a coordinate system serving as references for position measurements and so on, or the like. Typical examples of the geodetic system include the World Geodetic System 1984 (WGS 84).

The variable setting unit 23 is a processing unit that sets the variable d with which, when inverse stereographic projection of a plurality of satellites 1 and the receiver 10 onto the hypersurface is performed, their positions are inside a hyperboloid in the four-dimensional spacetime, which enables the linear equation (equation (5)) to be generated. Specifically, the variable setting unit 23 sets the variable d that meets a condition A “γ^{(s)}+d²>0 and r²−x₀²+d²>0 and d>0”. Note that γ^{(s)} is a variable using the times and positions of satellites and will be described in more detail below.

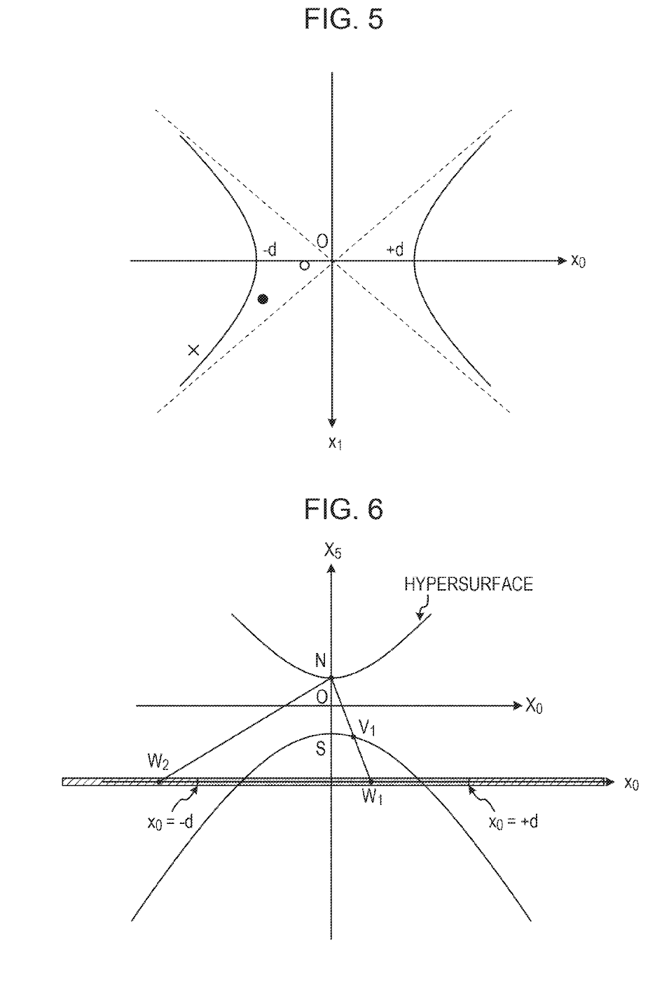

FIG. 5 is a diagram illustrating an area where it is determined whether or not inverse stereographic projection is possible regarding satellites, and is a diagram illustrating FIG. 3A or FIG. 3B by a plane of four-dimensional spacetime. In FIG. 5, by way of example, the case where the positions of all the satellites 1 and the receiver 10 may be written as (x₁, 0, 0) is handled. “O” represented in FIG. 5 indicates the previous position of the receiver 10. The white circle indicates the current position of the receiver 10. The black circle indicates a position of the satellite 1 that is on the side of the origin of a hyperboloid passing through ±d on the x₀ axis and where, thus, inverse stereographic projection is possible, and the mark X indicates a position of the satellite 1 that is not on the side of the origin of the hyperboloid passing through ±d on the x₀ axis, and where, thus, inverse stereographic projection is not possible.

That is, for the satellites 1 and the receiver 10 located in the range of “x₀” with which a line passing through the starting point N of inverse stereographic projection and the time axis of “x₀” of the four-dimensional spacetime may intersect the hypersurface, it may be determined that inverse stereographic projection is possible. Here, a specific description will be given with reference to FIG. 6. FIG. 6 is a diagram in which the diagram of FIG. 3A or FIG. 3B is taken along the X₀-X₅ plane and represents a set of points written as (X₀, 0, 0, 0, X₅). In the example of FIG. 6, a line W₁N intersects the hypersurface at a point V₁ and therefore the position of W₁ is a position where inverse stereographic projection is possible, and the line W₂N does not intersect the hypersurface and therefore the position of W₂ is a position where inverse stereographic projection is not possible.

In such a way, the variable setting unit 23 sets the variable d so that the positions of the satellites 1 are positions where inverse stereographic projection is possible. Next, a specific example regarding setting of the variable d will be described.

The variable setting unit 23 computes, for each satellite 1, using a potential function at the satellite, the variable d^{(s)} that minimizes the potential function, and selects, as the variable d, the variable d^{(s)} that is largest among a plurality of variables d^{(s)} computed. For example, the variable setting unit 23 selects the variable d that is largest among the variables d^{(s)} computed for five satellites, at the first time of measurement, and selects, as the variable d, the variable d^{(s)} that is largest among the variables d^{(s)} computed for four satellites, at the second or more time. Then, the variable setting unit 23 outputs the selected variable d to the equation generation unit 24.

Equation (6), equation (7), and equation (8) given below are examples of the potential function. Using the potential function of equation (6), equation (7), equation (8), and the like, the variable setting unit 23 computes the variable d^{(s)} that minimizes the potential function for each satellite 1, the receiver 10, and so on. Note that equation (6) is an example using a constrained potential function of a hydrogen atom, where “c” is the speed of light, “t₀” is a time at which measurement is carried out for the receiver 10 and “t^{(s)}” is a time at which measurement is carried out for each satellite 1. Equation (8) is an example using a Yukawa potential function.

$$\begin{matrix}h ( {d}^{( s )} ) = \frac{1}{c \vert {t}^{( s )} - {t}_{0} \vert - {d}^{( s )}} + \frac{1}{{d}^{( s )}} & ( 6 ) \\ h ( {d}^{( s )} ) = - \frac{ln ( {d}^{( s )} )}{{d}^{( s )}} & ( 7 ) \\ h ( {d}^{( s )} ) = \frac{100 {e}^{- 20 d ( s )}}{{d}^{( s )}} - \frac{1}{{d}^{( s )}} & ( 8 )\end{matrix}$$

The equation generation unit 24 is a processing unit that generates equation (5), which is a linear equation on the hypersurface. Specifically, the equation generation unit 24 generates equation (5) using origin information and position information input from the coordinate system setting unit 22 and the variable d input from the variable setting unit 23.

In addition, “α^{(s)}” and “β^{(s)}” in equation (5) are defined by equation (9). Equation (9), where parameter “Γ” is set to a value stored in the parameter DB 16b, is defined using variables in the four-dimensional spacetime and “d”.

$${α}^{( s )} = \frac{{γ}^{( s )} - {d}^{2}}{2 d} , {β}^{( s )} = \frac{Γ ( {γ}^{( s )} + {d}^{2} )}{2 d} \qquad ( 9 )$$

In addition, “γ^{(s)}” in equation (9) is defined by equation (10). Equation (10) defines “γ^{(s)}” using values in four-dimensional spacetime and defines it using a time “x₀^{(s)}” of each satellite and the position of each satellite “xᵢ^{(s)}” (i=1, 2, 3).

$$\begin{matrix}{γ}^{( s )} = - ( {x}_{0}^{( s )} ) + {\sum }_{i = 1}^{3} {( {x}_{i}^{( s )} )}^{2} & ( 10 ) \\ {x}_{0} = - \frac{d {X}_{0}}{{X}_{5} - Γ} , {x}_{i} = - \frac{d {X}_{i}}{{X}_{5} - Γ} & ( 11 )\end{matrix}$$

Then, the equation generation unit 24 computes “γ^{(s)}” by substituting position information “x₀^{(s)}, xᵢ^{(s)}” of the satellite 1 input from the coordinate system setting unit 22 into equation (10) and computes “α^{(s)}” and “β^{(s)}” by substituting “γ^{(s)}” and “d” into equation (9). Thereafter, the equation generation unit 24 outputs position information “x₀^{(s)}, xᵢ^{(s)}” of the satellite 1 input from the coordinate system setting unit 22, “α^{(s)}” and “β^{(s)}” computed using equation (9) and equation (10), and the variable d input from the variable setting unit 23 to the solution unit 25.

The solution unit 25 is a processing unit that solves a linear equation generated by the equation generation unit 24. Specifically, the solution 25 substitutes “x₀^{(s)}, xᵢ^{(s)}”, “α^{(s)}” and “β^{(s)}”, as well as the variable d, notified from the equation generation unit 24 into equation (5). Then, assuming that “i” is “1, 2, 3” and “s” is “1, 2, 3, 4, 5”, the solution unit 25 expands equation (5) and solves a simultaneous linear equation, thereby obtaining a five-dimensional parameter “X₀, Xᵢ, X₅”. Thereafter, the solution unit 25 outputs the obtained five-dimensional parameter “X₀, Xᵢ, X₅” and the variable d to the transformation unit 26.

The transformation unit 26 is a processing unit that transforms position information in the five-dimensional spacetime of the receiver 10 computed by the solution unit 25 into position information in four-dimensional spacetime. Specifically, the transformation unit 26 substitutes “X₀, Xᵢ, X₅” computed by the solution unit 25 into equation (11) and reads the value of “Γ” stored in the parameter DB 16b and substitutes the value into equation (11). Then, the transformation unit 26 identifies time information “x₀” and position information “xᵢ”=“x₁, x₂, x₃”=“x, y, z”.

Then, the transformation unit 26 stores the obtained position information “x, y, z” of the receiver 10 and the measured time “x₀=t₀” of the receiver 10 in the position DB 16a and outputs them to the output unit 27. Note that the transformation unit 26 may further associate the position information “X₀, Xᵢ, X₅” of the receiver 10 in the five-dimensional spacetime and store this information in the position DB 16a.

The output unit 27, which is a processing unit that outputs position information of the receiver 10 obtained by the transformation unit 26 to a mobile terminal, provides the position information to a mobile terminal so as to cause the position information to be displayed on a display device such as a display of the mobile terminal. For example, the output unit 27 may output information on movement from a position at which position information has been output previously, in addition to the position information of the receiver 10.

### [Process Flow]

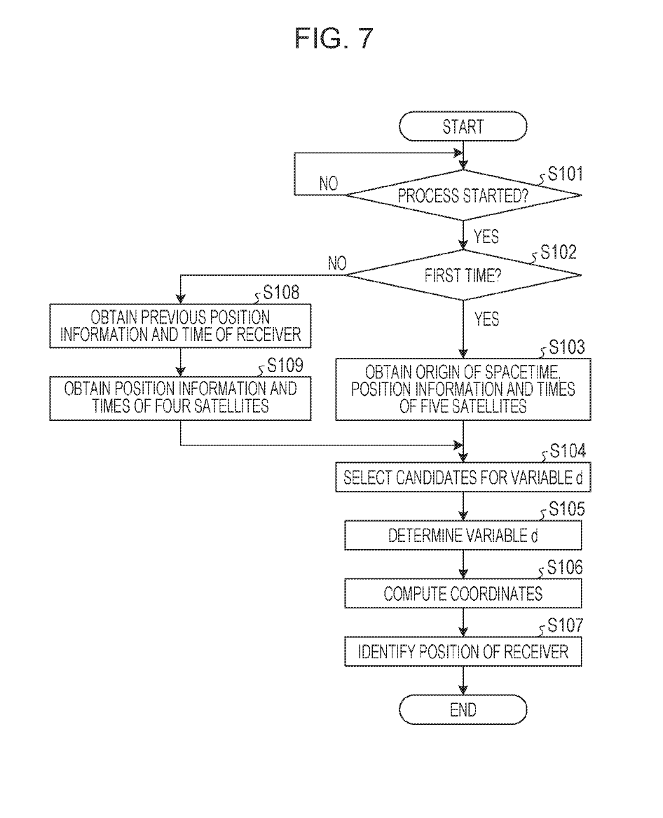

FIG. 7 is a flowchart illustrating a process flow. As illustrated in FIG. 7, when a process of carrying out a position measurement of the receiver 10 is started (S101: YES), then the obtaining unit 21 of the receiver 10 determines whether or not this is the first time measurement (S102).

When this is the first time measurement (S102: YES), the obtaining unit 21 obtains the origin of spacetime and the position information and times of five satellites (S103). Here, the coordinate system setting unit 22 sets the origin of time and the origin of space coordinates.

Subsequently, the variable setting unit 23 computes, for each satellite, the variable d^{(s)} that minimizes the value of a potential function (S104) and determines the maximum value among the variables d^{(s)} as the variable d (S105).

Thereafter, the solution unit 25 solves a linear equation generated using the variable d and so on by the equation generation unit 24 to compute coordinates (position) of the receiver 10 in five-dimensional spacetime (S106). Then, the transformation unit 26 transforms the coordinates of the receiver 10 in the five-dimensional spacetime into coordinates in four-dimensional spacetime to identify the position of the receiver 10 (S107).

On the other hand, in S102, when measurement is carried out for the second or more time (S102: NO), the obtaining unit 21 obtains the previous position information and time information of the receiver 10 from the position DB 16a (S108) and obtains the position information and times of four satellites (S109). Thereafter, the process in and after S104 is performed.

As described above, the receiver 10 may suppress successive approximation computations of a non-linear equation such as equation (1) and may identify positions using a linear equation, and thus may reduce power consumption.

The receiver 10 may also improve the measurement accuracy, as compared to a typical position measurement method, by selecting the variable d that satisfies the condition A and that is small but not exceedingly small, based on the arrangement of the receiver 10 and the satellites 1 at each measurement time. The receiver 10 may also determine the suitable variable d using known functions such as potential functions and thus reduce the computation cost.

### Second Embodiment

Although the embodiment of the present disclosure has been described, the present disclosure may be carried out in various different forms than the embodiment described above.

### [Cloud Environment]

Although, in the above embodiment, the example where the receiver 10 performs position identification has been described, the present disclosure is not limited to this example. For example, a server using a cloud service may perform the position identification processing mentioned above. Specifically, the server, upon receiving a request for position identification from the receiver 10, identifies the position of the receiver 10 through the use of a technique using the inverse stereographic projection mentioned above and notifies the receiver 10.

### [Potential Function]

Although the above embodiment illustrates the technique utilizing a potential function as a technique for selecting the suitable variable d, the present disclosure is not limited to this technique. For example, the variable d may be selected using the diagrams described with reference to FIG. 5 and FIG. 6. That is, regarding the distance between the origin O in four-dimensional spacetime, where the satellites 1 and the receiver 10 are present, and the starting point (the point N in FIG. 3A or FIG. 3B) of inverse stereographic projection on a hypersurface of five-dimensional spacetime, while keeping the distance to a value at which inverse stereographic projection of the positions of satellites 1 and the receiver 10 is possible, the receiver 10 sets the distance to a value at which a computation error caused when the distance is too large or too small is reduced to a small amount.

### [Number of Satellites]

Although, in the above embodiment, the example where information on five satellites (s=1, 2, 3, 4, 5) is obtained at the first time of measurement and information on four (s=1, 2, 3, 4) satellites and the previous position information of the receiver 10 are used at the second or more time has been described, the present disclosure is not limited to this. For example, information on five satellites may be also obtained and utilized at the second or more time of measurement. Note that using the previous position information of the receiver 10 at the second or more time of measurement enables movement histories, movement speeds, and the like of the receiver 10 to be easily grasped and enables the histories and the like to be displayed.

### [Hardware Configuration]

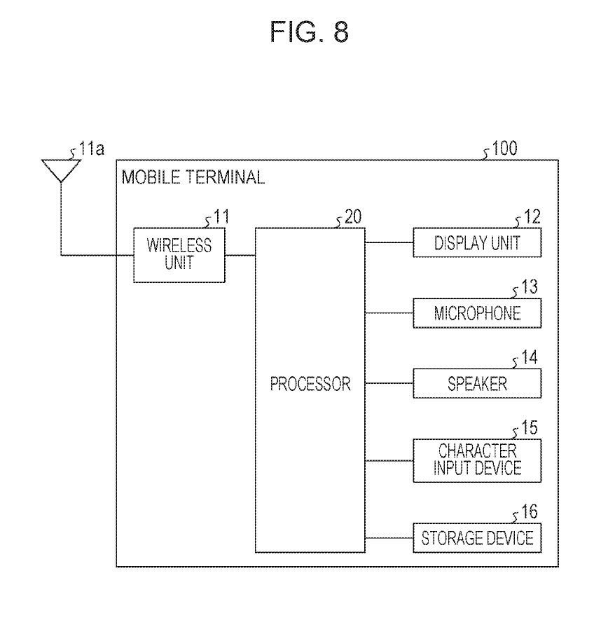

FIG. 8 is a diagram illustrating an example of a hardware configuration of a mobile terminal. As illustrated in FIG. 8, a mobile terminal 100 includes a wireless unit 11, a display device 12, a microphone 13, a speaker 14, a character input device 15, a storage device 16, and a processor 20. Note that the mobile terminal 100 in FIG. 8 is an example of a mobile terminal including the receiver 10 in FIG. 4.

The wireless unit 11 uses an antenna 11a to communicate with other receivers, base station devices and satellites. The display device 12, which is a display device such as a touch panel or a display, displays various kinds of information. The microphone 13 collects sound and inputs the sound to the processor 20. The speaker 14 outputs the sound input from the processor 20.

The character input device 15, which is a keyboard, a keyboard displayed on a touch panel, or the like, receives various inputs from the user and outputs them to the processor 20. The storage device 16, which is a storage device such as a memory or a hard disk, stores programs executed by the processor 20, processing results generated by programs executed by the processor 20, various tables, and so on.

The processor 20, which is a processing unit in charge of processing of the entire receiver 10, reads programs from the storage device 16 and executes processes. For example, the processor 20 causes processes that execute processing as with the obtaining unit 21, the coordinate system setting unit 22, the variable setting unit 23, the equation generation unit 24, the solution unit 25, the transformation unit 26, and the output unit 27 to operate. In addition, two or more processors 20 may be included.

### [System]

The configuration of each of devices illustrated in the drawings does not have to be physically made as illustrated. That is, the devices may configured so as to be distributed or integrated in arbitrary units. Furthermore, all or any part of processing functions performed in each device may be implemented by a central processing unit (CPU) and programs analyzed and executed by that CPU or may be implemented as hardware using wired logic.

All or part of processing described as being automatically performed among processing described in the present embodiment may be manually performed, or all or part of processing described as being manually performed may be automatically performed by a known method. In addition, processing procedures, control procedures, specific names, information including various kinds of data and parameters illustrated in the above document and drawings may be arbitrarily changed unless otherwise specified.

Note that the receiver 10 described in the present embodiment may perform functions similar to processing described with reference to FIG. 4 and so on when a position identification program is read and executed. For example, the receiver 10 deploys a program having functions similar to those of the obtaining unit 21, the coordinate system setting unit 22, the variable setting unit 23, the equation generation unit 24, the solution unit 25, the transformation unit 26, and the output unit 27 in memory. Then, the receiver 10 may perform processing as in the above embodiment by executing processes that perform processing as with the obtaining unit 21, the coordinate system setting unit 22, the variable setting unit 23, the equation generation unit 24, the solution unit 25, the transformation unit 26, and the output unit 27.

This program may be distributed over a network such as the Internet. The program may also be recorded on a computer-readable recording medium such as a hard disk, a flexible disk (FD), a compact disk read-only memory (CD-ROM), a magneto optical (MO), or a digital video disk (DVD) and may be executed by being read from the recording medium by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal comprising:
an obtaining unit that obtains position information and time information of a plurality of satellites;
a first output unit that outputs a variable for use for projection of a first coordinate system, to a projection surface defined in a second coordinate system, the second coordinate system being higher in dimension than the first coordinate system representing the position information and time information;
a second output unit that outputs coordinates of the second coordinate system where the projection surface is present, the coordinates being computed using the position information and time information and the variable; and
a transformation unit that transforms the coordinates output by the second output unit to coordinates of the first coordinate system.

2. The mobile terminal according to claim 1,
wherein the variable output by the first output unit is a variable that defines an offset between the projection surface and the first coordinate system in the second coordinate system, and
wherein the first output unit computes a variable with which projection of the position information and time information represented in the first coordinate system on the projection surface is possible.

3. The mobile terminal according to claim 2,
wherein the projection surface is a surface on which a path of light in the first coordinate system is representable by a linear equation, and
wherein the first output unit computes the variable with which the position information and time information are inside a hyperboloid in the first coordinate system determined from the projection surface and the variable.

4. The mobile terminal according to claim 2,
further comprising a selection unit that computes, from position information and time information of each of a plurality of satellites, a variable with which projection on the projection surface is possible, and performs selection from a plurality of variables computed,
wherein the first output unit outputs a variable selected by the selection unit.

5. The mobile terminal according to claim 4, wherein the selection unit computes, for the plurality of satellites, using potential functions in the satellites, the variables that minimize the potential functions, and selects the variable that is largest among the plurality of computed variables.

6. The mobile terminal according to claim 1,
wherein the obtaining unit obtains position information and time information of five satellites, at a first time of position measurement of the mobile terminal, and obtains position information and time information of four satellites, after the first time, and
the second output unit computes coordinates of the second coordinate system using the position information and time information of the five satellites and the variable, at the first time, and computes coordinates of the second coordinate system using the position information and time information of the four satellites, coordinates and time information of the mobile terminal measured last time, and the variable.

7. A position identification method performed by a computer, the method comprising:
obtaining position information and time information of a plurality of satellites;
outputting a variable for use for projection of a first coordinate system, to a projection surface in a second coordinate system, the second coordinate system being higher in dimension than the first coordinate system representing the position information and time information;
outputting coordinates of the second coordinate system where the projection surface is present, the coordinates being computed using the position information and time information and the variable; and
transforming the output coordinates to coordinates of the first coordinate system.

8. A position identification device comprising:
an obtaining unit that obtains position information and time information of a plurality of satellites;
a first output unit that outputs a variable for use for projection of a first coordinate system, to a projection surface defined in a second coordinate system, the second coordinate system being higher in dimension than the first coordinate system representing the position information and time information;
a second output unit that outputs coordinates of the second coordinate system where the projection surface is present, the coordinates being computed using the position information and time information and the variable; and
a transformation unit that transforms the coordinates output by the second output unit to coordinates of the first coordinate system.
